(19) United States
(12) Patent Application Publication
(10) Pub. No.: US 2026/0342167 A1
(43) Pub. Date: Oct. 29, 2026

(54) DRIVE DEVICE

(71) Applicant: DENSO CORPORATION, Kariya-city (JP)

(72) Inventor: Asuka TANAKA, Kariya-city (JP)

(21) Appl. No.: 19/712,262

(22) Filed: Jun. 18, 2026

Related U.S. Application Data
(63) Continuation of application No. PCT/JP2025/000322, filed on Jan. 8, 2025.

(30) Foreign Application Priority Data
Jan. 12, 2024 (JP) 2024-002979

(51) Int. Cl. H02K 5/02; H02K 11/30

(52) U.S. Cl. CPC H02K 5/02; H02K 11/30

(57) ABSTRACT

A motor portion and an ECU are integrally formed. A motor case is formed of a non-metal molding material. A tubular portion extends in an axial direction of the motor portion. A front bottom portion holds a front bearing that supports a shaft on a front side of the motor portion. A rear frame is a separate component from the motor case and holds a rear bearing that supports the shaft on a rear side of the motor portion. An ECU cover is formed of a resin material and covers a board of the ECU. An end portion of a lateral plate is joined to an end portion of the tubular portion of the motor case. A stator is molded with a stator molded portion molded of a non-metal molding material integrally with the tubular portion.

### CROSS-REFERENCE TO RELATED APPLICATION

The present application is a continuation application of International Patent Application No. PCT/JP2025/000322 filed on Jan. 8, 2025, which designated the U.S. and claims the benefit of priority from Japanese Patent Application No. 2024-002979 filed on Jan. 12, 2024. The entire disclosures of all of the above applications are incorporated herein by reference.

### TECHNICAL FIELD

The present disclosure relates to a drive device.

### BACKGROUND

Conventionally, a drive device for driving an electric motor has been known.

### SUMMARY

According to an aspect of the present disclosure, a drive device comprises: motor portion, in which a rotor is arranged inside of an annular stator in a radial direction and is configured to rotate integrally with a shaft; an ECU provided on one side of the motor portion in an axial direction and configured to control driving of the motor portion. The ECU and the motor portion are integrally formed. A side opposite to the ECU with respect to the motor portion is a front side, and an ECU side with respect to the motor portion being a rear side. The drive device may further comprise: a motor case formed of a non-metal molding material and including a tubular portion extending in the axial direction of the motor portion, and a front bottom portion holding a front bearing that supports the shaft on the front side of the motor portion. The tubular portion and the front bottom portion may be integrally formed. A rear frame may be a separate component from the motor case and holding a rear bearing that supports the shaft on the rear side of the motor portion. An ECU cover may be formed of a resin material in a container shape and covers a board of the ECU. An end portion of a lateral plate of the ECU cover may be joined to an end portion of the tubular portion of the motor case. The stator may be molded with a stator molded portion, which is molded with a non-metal molding material, integrally with the tubular portion of the motor case.

### BRIEF DESCRIPTION OF THE DRAWINGS

The above object and other objects, features, and advantages of the present disclosure will become more apparent from the following detailed description with reference to the accompanying drawings. In the drawings:

FIG. 1 is an overall configuration diagram showing an electric power steering apparatus to which a drive device is applied.

FIG. 2 is a cross-sectional view showing a schematic configuration of a drive device according to a first embodiment.

FIG. 3 is a view showing a structure as seen from an arrow III direction in FIG. 2.

FIG. 4 is a cross-sectional view showing a schematic configuration of a drive device according to a second embodiment.

FIG. 5 is a cross-sectional view showing a schematic configuration of a drive device according to a third embodiment.

FIG. 6 is a cross-sectional view showing a schematic configuration of a drive device according to a fourth embodiment.

### DETAILED DESCRIPTION

Hereinafter, examples of the present disclosure will be described.

According to an example of the present disclosure, a drive device includes an ECU (control unit) that is integrally provided at one end of the drive device in an axial direction of a motor portion. In the drive device, a stator is fixed to an inner side of a tubular portion of a metal motor case. A space between the tubular portion of the motor case and a resin ECU cover is sealed with an adhesive.

In the drive device, the motor case is formed of, for example, metal. In this case, there is a possibility that the exposed metal contacts moisture in the air or rainwater containing salt water and corrodes, and the sealing performance of a bonding portion between the motor case and the ECU cover may deteriorate. Further, in case where the motor case is metal, the weight of the motor portion becomes heavy. Furthermore, there is an issue that the stator fixed to the motor case is susceptible to vibration of the motor.

According to an example of the present disclosure, a drive device is configured such that a motor portion in which a rotor arranged inward in a radial direction of an annular stator rotates integrally with a shaft, and an ECU provided on one side in an axial direction of the motor portion and configured to control driving of the motor portion, are integrally formed.

A side opposite to the ECU with respect to the motor portion is defined as a front side. An ECU side with respect to the motor portion is defined as a rear side. A drive device of a first example comprises a motor case, a rear frame, and an ECU cover. A drive device of a second example comprises a motor case, a front frame, and an ECU cover.

The motor case is formed of a non-metal molding material. The motor case may be formed of a carbon fiber composite material (CFRP) or a resin material having a blending ratio of glass fibers (GF) of 35% or more.

In the motor case in the first example, a tubular portion extending in the axial direction of the motor portion, and a front bottom portion holding a front bearing that supports the shaft on the front side of the motor portion are integrally formed. In the motor case in the second example, a tubular portion extending in the axial direction of the motor portion, and a rear bottom portion holding a rear bearing that supports the shaft on the rear side of the motor portion are integrally formed.

The rear frame in the first example is a separate component from the motor case, and holds the rear bearing that supports the shaft on the rear side of the motor portion. The front frame in the second example is a separate component from the motor case, and holds the front bearing that supports the shaft on the front side of the motor portion.

Common to the first and second examples, the ECU cover is formed of a resin material in a container shape covering a board of the ECU, and an end portion of a lateral plate is joined to an end portion of the tubular portion of the motor case. The ECU cover may be formed of a resin material different from a material of the motor case.

Common to the first and second examples, the stator is molded with a non-metal molding material. In addition, a stator molded portion molding the stator is molded integrally with the tubular portion of the motor case.

In the drive device of the present disclosure, since the inside of the motor portion and the ECU is covered with the motor case formed of the non-metal molding material and the ECU cover formed of the resin material, the corrosion resistance is improved. Further, since the non-metal molding material is generally a resin-based composite material and has a specific gravity smaller than that of metal, the weight reduction of the motor portion is enabled. Furthermore, since the stator molded portion molding the stator is molded integrally with the tubular portion of the motor case with the non-metal molding material, the rigidity of the stator increases, and the vibration is suppressed.

A plurality of embodiments of a drive device according to the present disclosure will be described with reference to the drawings. In the plurality of embodiments, substantially the same components are denoted by the same reference numerals, and description thereof will be omitted. The first to fourth embodiments are comprehensively referred to as “the present embodiment”. The drive device of the present embodiment is applied, for example, as a steering assist motor of an electric power steering apparatus, and a motor portion and an ECU configured to control driving of the motor portion are integrally configured.

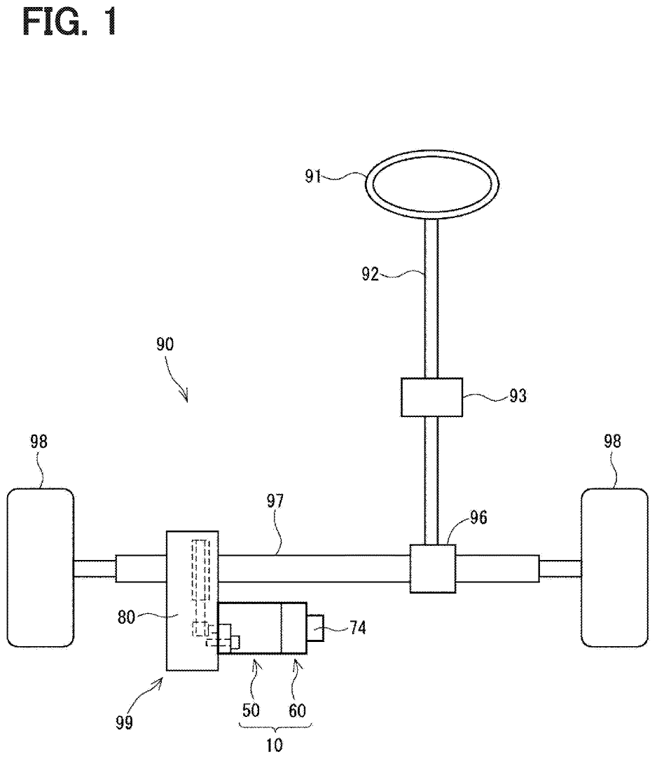

A schematic configuration of an electric power steering apparatus 99 will be described with reference to FIG. 1. A rack-assist type electric power steering apparatus is illustrated as an example, but a drive device 10 of the present embodiment is similarly applicable to a column-assist type electric power steering apparatus. A steering system 90 including the electric power steering apparatus 99 comprises a steering wheel 91, a steering shaft 92, a pinion gear 96, a rack shaft 97, wheels 98, the electric power steering apparatus 99, and the like.

A torque sensor 93 configured to detect a steering torque is provided on the steering shaft 92 to which the steering wheel 91 is connected. The pinion gear 96 configured to mesh with the rack shaft 97 is provided at a distal end of the steering shaft 92. When a driver rotates the steering wheel 91, a rotational motion of the steering shaft 92 is converted into a linear motion of the rack shaft 97 by the pinion gear 96. A pair of the wheels 98 coupled to both ends of the rack shaft 97 are steered to an angle corresponding to a displacement amount of the rack shaft 97.

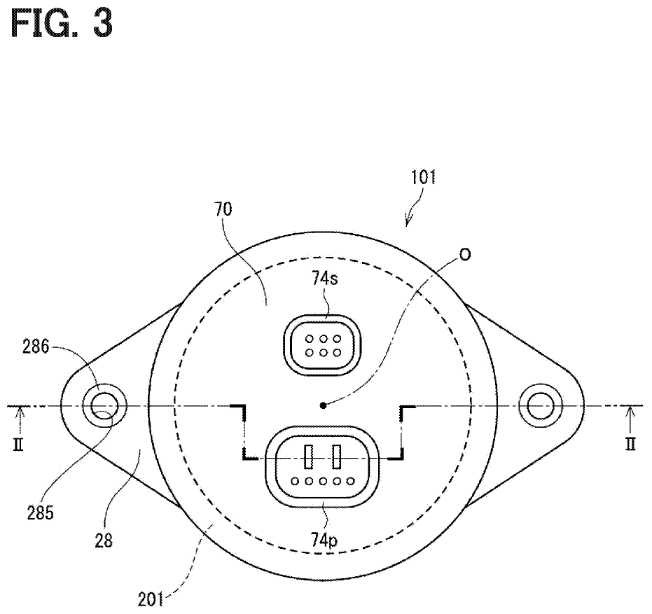

The electric power steering apparatus 99 comprises the drive device 10, a gear box 80, and the like. The drive device 10 has a so-called “electromechanical integrated” configuration in which a motor portion 50 and an ECU 60 configured to control driving of the motor portion 50 are integrally configured. The motor portion 50 is fixed to an end surface of the gear box 80 with a bolt using an attachment hole 285 (see FIG. 3) provided in a motor flange portion 28. A reduction gear configured to decelerate rotation of the motor portion 50 and transmit the decelerated rotation to the rack shaft 97 is accommodated in the gear box 80.

In the drive device 10 of the present embodiment, the motor portion 50 is a two-system three-phase brushless motor having two sets of three-phase windings. The ECU 60 supplies power to the two sets of three-phase windings by two systems of inverter circuits. DC power is supplied from a battery to a connector 74 of the ECU 60, and a communication signal with a vehicle communication network (CAN) is input and output. Further, a sensor signal is input from the torque sensor 93. By supplying three-phase AC power converted from the DC power by the inverter circuits of the ECU 60, the motor portion 50 outputs a steering assist torque.

By the way, in the rack-assist type electric power steering apparatus, moisture such as rainwater and dew condensation water easily enters the drive device, and waterproofing property is particularly required. Therefore, a space between the motor case and the ECU cover is sealed with an adhesive. However, if the metal motor case is exposed, there is a possibility that the sealing performance deteriorates due to corrosion of the metal caused by contact with moisture (including salt water). Further, when the motor case is metal, the weight of the motor portion becomes heavy. Furthermore, there is a problem that the stator fixed to the motor case is susceptible to vibration of the motor.

Therefore, in the drive device 10 of the present embodiment, in order to improve corrosion resistance and reduce weight, all exposed portions covering the inside of the motor portion 50 and the ECU 60 are formed of a non-metal material. Further, in order to suppress vibration, the stator is molded with a non-metal molding material, and a stator molded portion molding the stator is molded integrally with the motor case. Subsequently, configurations of the drive device 10 of each embodiment will be described in order. For the reference numerals of the drive devices of the first to fourth embodiments, the number of the embodiment is added to a third digit following “10”.

### First Embodiment

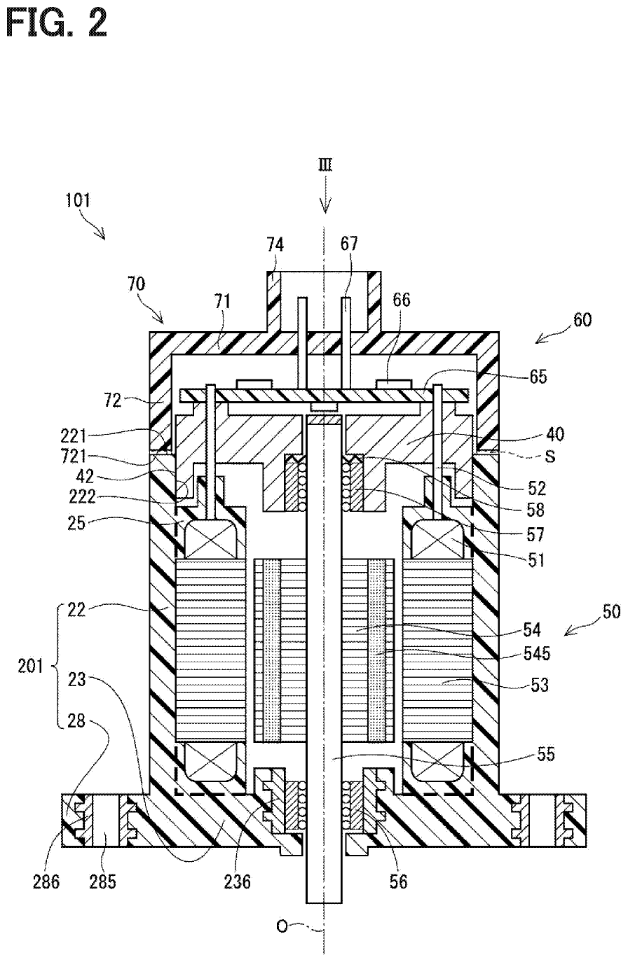

A drive device 101 of a first embodiment will be described with reference to FIGS. 2 and 3. In FIG. 2, a direction parallel to a rotation axis O of the motor portion 50 is defined as an “axial direction”, and a direction orthogonal to the axial direction is defined as a “radial direction”. A stator 53, a rotor 54, and a shaft 55 are arranged coaxially with the rotation axis O. In the motor portion 50, the rotor 54 arranged inward in a radial direction of the annular stator 53 rotates integrally with the shaft 55. The ECU 60 is provided on one side in the axial direction of the motor portion 50. A side opposite to the ECU 60 with respect to the motor portion 50 is defined as a “front side”, and an ECU 60 side with respect to the motor portion 50 is defined as a “rear side”.

In the stator 53, a motor winding 51 is wound around an annular stator core. A lead wire 52 of the motor winding 51 is connected to a board 65 of the ECU 60. By controlling energization to the motor winding 51 by the ECU 60, a rotating magnetic field is formed in the stator 53. The rotor 54 is provided with a plurality of permanent magnets 545 along an outer circumference of a rotor core. The rotor 54 rotates about the shaft 55 by the rotating magnetic field formed in the stator 53.

The shaft 55 is fixed to a center of the rotor 54. A front bearing 56 rotatably supports the shaft 55 on the front side of the motor portion 50. A rear bearing 57 rotatably supports the shaft 55 on the rear side of the motor portion 50. A wave washer 58 is interposed on a bearing surface of the rear bearing 57.

The drive device 101 of the first embodiment comprises a motor case 201, a rear frame 40, and an ECU cover 70. The motor case 201 is formed of a non-metal molding material, and a tubular portion 22, a front bottom portion 23, and a motor flange portion 28 are integrally formed. The tubular portion 22 extends in the axial direction of the motor portion 50 outward in the radial direction of the stator 53. The front bottom portion 23 forms a bottom portion on the front side of the motor portion 50, and holds the front bearing 56. Specifically, a metal holding collar 236 into which the front bearing 56 is press-fitted is insert-molded at a center portion of the front bottom portion 23.

As shown in FIG. 3, the motor flange portion 28 is provided so as to protrude outward in the radial direction at two locations in a circumferential direction that are on opposite sides to each other across the rotation axis O. A metal fastening collar 286 having the attachment hole 285 is insert-molded in the motor flange portion 28. By fastening a bolt to a screw hole of the gear box 80 through the attachment hole 285, the drive device 101 is fixed to the gear box 80.

The motor case 201 of the first embodiment has a bottomed tubular shape opening on the rear side. Therefore, for example, a parting line of a molding die is set near an opening surface on the rear side, and a space up to the front bottom portion 23 is formed by a core protruding from the parting line.

As the “non-metal molding material” that is a material of the motor case 201, preferably, a carbon fiber composite material (CFRP) or a resin material having a blending ratio of glass fibers (GF) of 35% or more is used. Therefore, the motor case 201 forming an outer shell of the motor portion 50 has enhanced strength.

The stator 53 is molded with a non-metal molding material (that is, a resin-based material). A non-metal material portion molding the stator 53 is referred to as a stator molded portion 25. The stator molded portion 25 is molded integrally with the tubular portion 22 of the motor case 201. In FIG. 2, common resin hatching is applied to the motor case 201 and the stator molded portion 25, and a broken line is drawn on a boundary surface. This broken line illustration suggests that the boundary surface is melted in an appearance of a completed product and the motor case 201 and the stator molded portion 25 cannot be distinguished from each other, but there is a possibility that both are manufactured in separate steps in a manufacturing process. Specifically, the following two manufacturing methods are possible.

[1] The motor case 201 and the stator molded portion 25 are simultaneously molded in one step with a die in which the stator 53 is inserted. In this case, the stator molded portion 25 is molded integrally with the tubular portion 22 of the motor case 201 with the same material as the motor case 201. That is, it can be simply expressed as “the stator 53 is integrally molded in the tubular portion 22 of the motor case 201.” With this configuration, a die structure can be made relatively simple, and molding can be performed with a general injection molding machine.

[2] First, the stator 53 is molded with a primary molding material using a die for primary molding. Next, a semi-finished product after the primary molding including the stator 53 and the stator molded portion 25 is inserted into a die for secondary molding, and is molded integrally with the tubular portion 22 of the motor case 201 with a secondary molding material. In this case, the primary molding material and the secondary molding material may be the same material or different materials. However, when the same material is used, the method [1] may be adopted, and there is no advantage in intentionally adopting the laborious method [2]. Therefore, when the method [2] is adopted, it is substantially expressed as “the stator molded portion 25 is formed of a material different from the motor case 201, and is molded integrally with the tubular portion 22 of the motor case 201.”

In this configuration, it is necessary to use a special molding machine such as a multi-color molding machine using two dies, which are the die for the primary molding and the die for the secondary molding. However, a material according to each characteristic can be used selectively, such that a high-strength material is used for the motor case 201, and a material advantageous for suppression of heat generation, magnetic transmission, cost reduction, and the like is used for the stator molded portion 25.

In order to investigate whether the material of the stator molded portion 25 and the material of the motor case 201 are the same or different for the completed product of the drive device, a determination can be made by, for example, cutting the product, cutting out a sample of each portion, and performing a chemical analysis.

The rear frame 40 is a separate component from the motor case 201, and is formed of a metal such as an aluminum alloy. The rear frame 40 is fixed to the motor case 201 by fitting a fitting outer wall 42 to a fitting inner wall 222 of the tubular portion 22 of the motor case 201. The rear frame 40 holds the rear bearing 57, and supports the board 65 of the ECU 60. Heat generated by electronic elements 66 (mainly switching elements of the inverter circuits) mounted on the board 65 is dissipated to the rear frame 40. That is, the rear frame 40 functions as a heat sink.

The ECU cover 70 is formed of a resin material such as PBT different from the material of the motor case 201. The ECU cover 70 is formed in a container shape having a top plate 71 and a lateral plate 72, and covers the board 65 of the ECU 60. Since the ECU cover 70 does not require a strength as high as that of the motor case 201, wear of a die can be suppressed, and a life of the die can be extended by using a resin material not containing carbon fibers or glass fibers.

A connector 74 opening toward a side opposite to the motor portion 50 is integrally formed on the top plate 71. The connector 74 is connected to the board 65 via a connector terminal 67. In an example shown in FIG. 3, a vehicle-system connector 74p having a power supply terminal and a CAN communication terminal, and a signal-system connector 74s having a sensor signal terminal are provided. However, the number of frontages and arrangement of the connectors 74 are not limited to this example. For example, in a drive device into which power and signals are redundantly input, two sets of the vehicle-system connectors and the signal-system connectors may be respectively provided. Further, a configuration in which directions of the connectors are different will be described later as a fourth embodiment.

An end portion 721 of the lateral plate 72 of the ECU cover 70 is joined to an end portion 221 of the tubular portion 22 of the motor case 201 with an adhesive S. Although detailed illustration of a portion filled with the adhesive S is omitted, an adhesive groove may be formed. Thus, a space between the ECU cover 70 and the motor case 201 is sealed, and entry of rainwater and the like is prevented.

As described above, in the drive device 101 of the first embodiment, since the inside of the motor portion 50 and the ECU 60 is covered with the motor case 201 formed of the non-metal molding material and the ECU cover 70 formed of the resin material, the corrosion resistance is improved. Further, since the non-metal molding material is generally a resin-based composite material and has a specific gravity smaller than that of metal, the weight reduction of the motor portion 50 is realized.

Furthermore, since the stator molded portion 25 molding the stator 53 is molded integrally with the tubular portion 22 of the motor case 201 with the non-metal molding material, the rigidity of the stator 53 increases, and the vibration is suppressed. Further, since the stator 53 and the motor case 201 become a single component, the number of components in an assembly step is reduced.

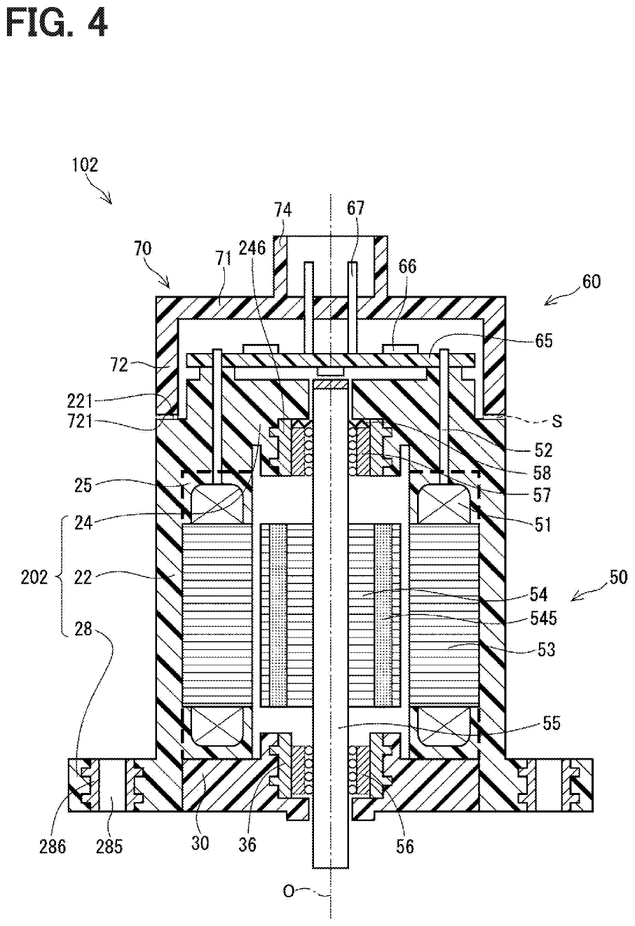

Next, with reference to FIGS. 4 to 6, second to fourth embodiments in which a part of the configuration is different from the first embodiment will be sequentially described. In any of the embodiments, motor cases 201, 202 are formed of a non-metal molding material, specifically, a carbon fiber composite material or a resin material having a blending ratio of glass fibers of 35% or more. ECU covers 70, 704 are formed of a resin material different from the motor cases 201, 202.

The stator 53 is molded with a non-metal molding material that is a same or different material as the motor cases 201, 202. The stator molded portion 25 molding the stator 53 is molded integrally with the tubular portion 22 of the motor cases 201, 202.

Basic operational effects of this configuration are the same as those of the first embodiment. That is, the drive device of each embodiment has improved corrosion resistance, and the motor portion 50 is reduced in weight. Further, the vibration of the stator 53 is suppressed. Hereinafter, differences in other configurations and operational effects will be mainly described.

### Second Embodiment

A drive device 102 of a second embodiment will be described with reference to FIG. 4. In the second embodiment, configurations of a motor case and a frame constituting a housing of the motor portion 50 are different from the drive device 101 of the first embodiment. In the motor case 202 of the drive device 102, the tubular portion 22, a rear bottom portion 24, and the motor flange portion 28 are integrally formed. The ECU cover 70 is the same as that of the first embodiment.

The rear bottom portion 24 holds the rear bearing 57 and supports the board 65 instead of the rear frame 40 of the first embodiment. A metal holding collar 246 into which the rear bearing 57 is press-fitted is insert-molded at a center portion of the rear bottom portion 24.

The motor case 202 of the second embodiment has a bottomed tubular shape opening on the front side. Therefore, for example, a parting line of a molding die is set near an opening surface on the front side, and a space up to the rear bottom portion 24 is formed by a core protruding from the parting line.

Further, the drive device 102 comprises a front frame 30. The front frame 30 is a separate component from the motor case 202, and holds the front bearing 56. The front frame 30 is formed of a non-metal material similarly to the motor case 202, and an outer peripheral wall is fitted inside the motor flange portion 28 of the motor case 202. A metal holding collar 36 into which the front bearing 56 is press-fitted is insert-molded at a center portion of the front frame 30.

Since not only the motor case 202 but also the front frame 30 is formed of a non-metal material, an effect of improving the corrosion resistance of the motor portion 50 is maintained. Furthermore, in the second embodiment, since the motor case 202 and the rear bottom portion 24 have an integral structure, a strength in a rear direction can be ensured under an environment with high stress in the rear direction.

### Third Embodiment

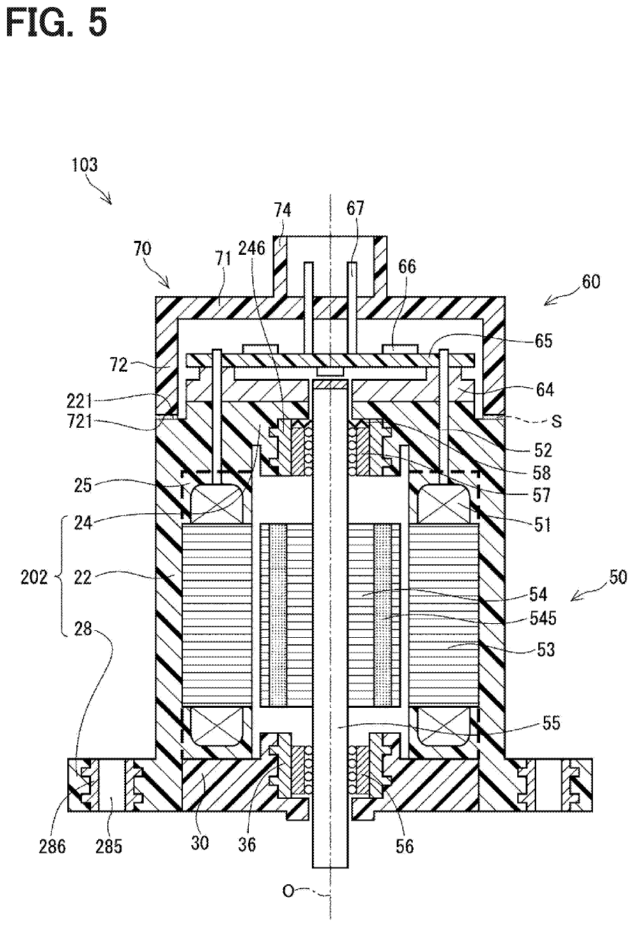

A drive device 103 of a third embodiment will be described with reference to FIG. 5. In addition to the configuration of the drive device 102 of the second embodiment, the drive device 103 comprises a metal plate 64 between the board 65 of the ECU 60 and the rear bottom portion 24. The metal plate 64 is formed of an aluminum alloy or the like. Heat generated by the electronic elements 66 (mainly the switching elements of the inverter circuits) mounted on the board 65 is dissipated to the metal plate 64. That is, the metal plate 64 functions as a heat sink similarly to the rear frame 40 of the first embodiment. Further, the metal plate 64 supports the board 65.

Since the heat of the electronic elements 66 is dissipated to the metal plate 64 provided between the board 65 and the non-metal rear bottom portion 24, functional deterioration or failure due to a temperature rise of the ECU 60 during driving of the motor can be prevented.

### Fourth Embodiment

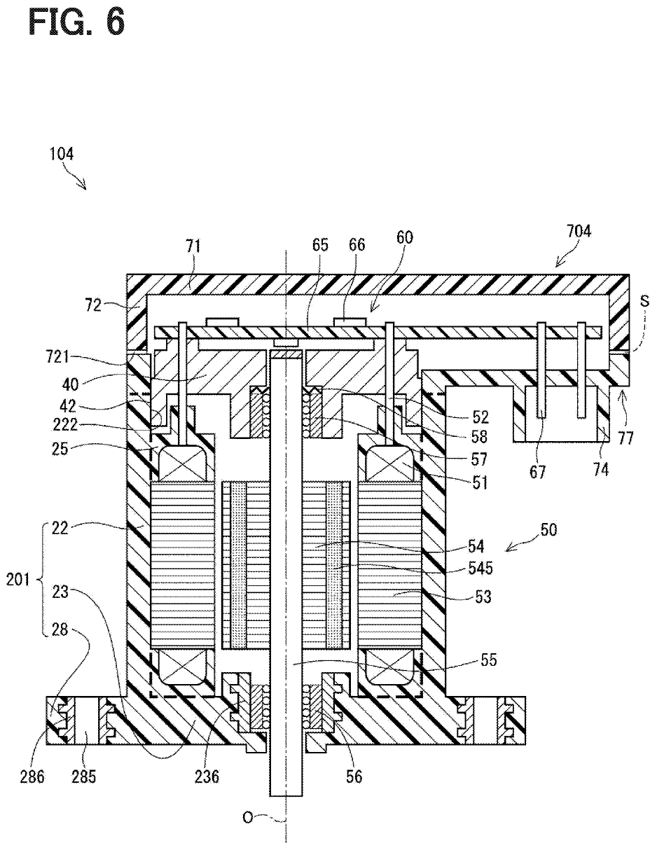

A drive device 104 of a fourth embodiment will be described with reference to FIG. 6. The drive device 104 has the same configuration of the motor portion 50 as the drive device 101 of the first embodiment, and an ECU cover has a different shape in relation to the arrangement of the connector 74. The ECU cover 704 of the drive device 104 is formed so as to protrude to one side in the radial direction of the motor portion 50. The connector 74 opening from a protruding portion of the ECU cover 704 to the front side (downward in the drawing) is provided.

In the ECU cover 704, an upper cover including the top plate 71 and the lateral plate 72, and a lower cover 77 in the protruding portion are formed separately, and are joined with an adhesive. As a boundary portion is indicated by a broken line in FIG. 6, the lower cover 77 and the motor case 201 may be formed separately, or may be formed integrally. By integrally forming them, the number of components can be reduced. Note that, an ECU cover 704 having a form protruding to one side in the radial direction of the motor portion 50 may be similarly applied to the drive devices 102, 103 of the second and third embodiments.

### Other Embodiments

(a) In the above embodiment, the motor flange portion 28 for attaching the drive device 10 to the end surface of the gear box 80 is formed integrally with the motor cases 201, 202. However, an attachment target object of the drive device 10 is not limited to the gear box 80, and an attachment method is not necessarily a flange method. In a configuration not using a flange or the like, the motor flange portion may not be formed on the motor case.
(b) Configurations of the board 65 and the connector 74 of the ECU 60 are not limited to the configurations exemplified in the above embodiment. For example, a plurality of boards may be arranged to be laminated.
(c) The drive device 10 of the present disclosure is not limited to the steering assist motor of the electric power steering apparatus, and may be used as a reaction motor or a turning motor of a steer-by-wire system, or a drive device of any other motor.

As described above, the present disclosure is not limited to the above embodiment at all, and can be implemented in various forms without departing from the spirit thereof.

The present disclosure has been described in accordance with the embodiments. However, the present disclosure is not limited to the embodiments and structures. The present disclosure also includes various modifications and modifications within an equivalent range. Furthermore, various combinations and forms, and other combinations and forms including only one element, more, or less, are also within the scope and spirit of the present disclosure.

What is claimed is

1. A drive device comprising:
a motor portion, in which a rotor is arranged inside of an annular stator in a radial direction and is configured to rotate integrally with a shaft;
an ECU provided on one side of the motor portion in an axial direction and configured to control driving of the motor portion, the ECU and the motor portion being integrally formed, a side opposite to the ECU with respect to the motor portion being a front side, and an ECU side with respect to the motor portion being a rear side;
a motor case formed of a non-metal molding material and including
a tubular portion extending in the axial direction of the motor portion and
a front bottom portion holding a front bearing that supports the shaft on the front side of the motor portion, the tubular portion and the front bottom portion being integrally formed;
a rear frame being a separate component from the motor case and holding a rear bearing that supports the shaft on the rear side of the motor portion; and
an ECU cover formed of a resin material in a container shape and covering a board of the ECU, an end portion of a lateral plate of the ECU cover being joined to an end portion of the tubular portion of the motor case, wherein
the stator is molded with a stator molded portion, which is molded with a non-metal molding material, integrally with the tubular portion of the motor case.

2. A drive device comprising:
a motor portion, in which a rotor is arranged inside of an annular stator in a radial direction and is configured to rotate integrally with a shaft;
an ECU provided on one side of the motor portion in an axial direction and configured to control driving of the motor portion, the ECU and the motor portion being integrally formed, a side opposite to the ECU with respect to the motor portion being a front side, and an ECU side with respect to the motor portion being a rear side;
a motor case formed of a non-metal molding material and including
a tubular portion extending in the axial direction of the motor portion, and
a rear bottom portion holding a rear bearing that supports the shaft on the rear side of the motor portion, the tubular portion and the rear bottom portion being integrally formed;
a front frame being a separate component from the motor case and holding a front bearing that supports the shaft on the front side of the motor portion; and
an ECU cover formed of a resin material in a container shape and covering a board of the ECU, an end portion of a lateral plate of the ECU cover being joined to an end portion of the tubular portion of the motor case, wherein
the stator is molded with a stator molded portion, which is molded with a non-metal molding material, integrally with the tubular portion of the motor case.

3. The drive device according to claim 2, further comprising:
a metal plate provided between the board of the ECU and the rear bottom portion of the motor case, wherein
the metal plate is configured to dissipate heat generated by an electronic element mounted on the board.

4. The drive device according to claim 1, wherein
the motor case is formed of a material that is a carbon fiber composite material or a resin material containing glass fiber at a blending ratio of 35% or more, and
the ECU cover is formed of a resin material different from the material of the motor case.

5. The drive device according to claim 4, wherein
the stator molded portion is molded with a material, which is same as the motor case, integrally with the tubular portion of the motor case.

6. The drive device according to claim 4, wherein
the stator molded portion is molded with a material, which is different from the motor case, integrally with the tubular portion of the motor case.
